(19) United States
(12) Patent Application Publication
(10) Pub. No.: US 2008/0099960 A1
(43) Pub. Date: May 1, 2008

(54) Deformation Method of Polymer Film or Fiber, and Polymer Actuator

(76) Inventor: Hidenori Okuzaki, Yamanashi (JP)

Correspondence Address: BIRCH STEWART KOLASCH & BIRCH, PO BOX 747, FALLS CHURCH, VA, 22040-0747, US

(21) Appl. No.: 11/661,384

(22) PCT Filed: Aug. 30, 2005
(86) PCT No.: PCT/JP05/15785

§ 371 Date: Feb. 28, 2007

(30) Foreign Application Priority Data
Aug. 31, 2004 (JP) 2004-253398

(51) Int. Cl. C08J 5/14

(52) U.S. Cl. 264/405; 264/291; 425/383; 425/174

(57) ABSTRACT

A polymer film or fiber having abilities of rapid and repeated stretching, contraction and deformation in a gas such as air (dry system), achieves deformation ratio of 10 times or more compared to conventional methods.

In the deformation method of a polymer film or fiber by absorption and desorption of molecules by an external stimulus, the external stimulus is applied to the polymer film or fiber in a deformed state so as to generate an internal force, by which the elastic modulus of the polymer film or fiber in the deformed state is changed, and then the polymer film or fiber is deformed.

### TECHNICAL FIELD OF THE INVENTION

The present invention relates to a deformation method of a polymer film or fiber, generating an internal force by deforming the original shape of a polymer film or fiber by an external force, and in a state where the internal force is generated, applying an external stimulus whereby absorption and desorption of molecules are caused to deform the polymer film or fiber, and also relates to a polymer actuator using the deformation method.

### BACKGROUND ART

Deformation methods of a polymer film or fiber by an external force are disclosed in the following patents by Hidenori Okuzaki and coworkers.

The following patents disclose methods of stretching and contracting, or bending a polypyrrole film or fiber in a gas by absorption and desorption of molecules by an electrical stimulus.

The stretch/contraction ratio of a polypyrrole film or fiber disclosed in the following patens is approximately 1.5-2% from FIG. 3 or 4 in Patent document 1 (Japanese patent publication No. 3131180), or FIG. 4 or 5 in Patent document 2 (Japanese patent publication No. 3102773). Thus, the deformation ratio of a polypyrrole film or fiber provided by the methods disclosed in these patents is about several percents at maximum.

Patent document 1: Japanese patent publication No. 3131180

Patent document 2; Japanese patent publication No. 3102773

Patent document 3; Japanese patent publication No. 3039994

### DESCRIPTION OF THE INVENTION

### Problems to be Solved by the Invention

Since the deformation methods of a polypyrrole film in the aforementioned patents are to be performed in a gas (dry system) and to provide a sensitive response to an electrical stimulus, they are expected to be applied to various products. For example, they can be applied to Braille displays for visually impaired persons, or to opening/closing devices for air conditioning dampers.

However, with deformation ratio of several percents, in the case of applying to Braille displays, there is a problem that it is difficult for visually impaired persons to thoroughly recognize a change in the deformation by touching with their fingers. Also, in the case of applying to opening/closing devices, there is a problem that it is difficult to ensure complete opening/closing. Thus, in the case of applying the techniques disclosed in Patent document 1-3 to actual products, there is a problem that it is not necessarily ensure enough deformation ratio with the disclosed techniques.

Therefore, the aim of the present invention is to solve the problem that conventional techniques achieve deformation ratio of only several percents. Thus, one object of the present invention is to provide a polymer film or fiber that can be rapidly and repeatedly stretched, contracted and deformed by a conventional external stimulus in a gas such as air (dry system), and to provide a deformation method of a polymer film or fiber that can achieve deformation ratio of 10 times or more.

The other object of the present invention is to provide a polymer actuator using a polymer film or fiber having the deformation ratio above.

### Means of Solving the Problems

This invention, expressed in the most in principle, is to provide a deformation method of a polymer film or fiber, applying an external force to a polymer film or fiber to deform it, and then applying an external stimulus to the polymer film or fiber in a deformed state whereby absorption and desorption of molecules are caused to deform the polymer film or fiber.

The polymer films and fibers in this description include neutral polymers, polyelectrolytes, and conducting polymers. Examples of neutral polymers include at least one selected from cellulose, cellophane, nylon, polyvinyl alcohol, vinylon, polyoxymethylene, polyethylene glycol, polypropylene glycol, polyvinylpyrrolidone, polyvinylphenol, poly(2-hydroxyethyl methacrylate), and derivatives of the above.

Examples of polyelectrolytes include at least one selected from polycarboxylic acids such as polyacrylic acid and polymethacrylic acid, polysulfonic acids such as polystyrenesulfonic acid, poly-2-acrylamido-2-methyl propane sulfonic acid and Nafion, polyamines such as polyallylamine and polydimethyl propylacrylamide, quaternized polyamines, and derivatives of the above.

Examples of conducting polymers include at least one selected from polythiophene, polypyrrole, polyaniline, polyacetylene, polydiacetylene, polyphenylene, polyfuran, polyselenophene, polytellurophene, polyisothianaphthene, polyphenylene sulfide, polyphenylenevinylene, polythienylenevinylene, polynaphthalene, polyanthracene, polypyrene, polyazulene, polyfluorene, polypyridine, polyquinoline, polyquinoxaline, polyethylenedioxythiophene, and derivatives of the above.

These polymer films and fibers can be fabricated using at least one selected from a casting method, a bar coating method, a spin coating method, a spray method, an electropolymerization method, a chemical oxidation polymerization method, a melt-spinning technique, a wet-spinning technique, a solid-state extrusion technique, and an electrospinning technique.

It is preferable to dope a dopant in order to improve the hygroscopicity and the electrical conductivity of these polymers. Examples of dopants include at least one selected from sulfuric acid, hydrochloric acid, nitric acid, phosphoric acid, iodine, bromine, arsenic fluoride, perchloric acid, tetrafluoroborate, hexafluorophosphate, alkylbenzenesulfonic acid, alkylsulfonic acid, perfluorosulfonic acid, polystyrene sulfonic acid, trifluoromethanesulfonic acid, trifluoromethanesulfonic acid, oxalic acid, acetic acid, maleic acid, phthalic acid, polyacrylic acid, polymethacrylic acid, derivatives of the above, carbonaceous additives such as carbon black, carbon fiber, carbon nanotube and fullerene, and metals such as iron, copper, gold and silver. Among them, an electropolymerized film of polypyrrole doped with tetrafluoroborate with high conductivity and with good stability and reproducibility is preferable.

Examples of means of absorption and desorption of polymer film or fiber molecules by an external stimulus include at least one selected from heating with nichrome wire, a torch, a burner, infrared irradiation, laser irradiation or microwave irradiation, depressurizing with a vacuum pump or an aspirator, and Joule heating with voltage application such as direct current wave, alternating current wave, triangular wave, rectangular wave or pulse wave. Among them, a direct current voltage with ease of use and good controllability is preferable.

It is preferable to apply an external stimulus in a state where an internal force such as an internal stress is generated in a polymer film or fiber. For example, regarding stimulus application in the elastically deformable region, an external stimulus can be applied under a mixture of the elastically deformable region and the plastically deformable region.

When a certain amount of internal force, for example, internal stress (σ) exists in a polymer film or fiber and if the elastic modulus (E) increases by an external stimulus, the applied strain (ε) decreases inversely proportional to the elastic modulus (see Formula 1). The deformed volume (ε−ε′) at the time increases in proportion to the internal stress (σ) and the difference of the elastic modulus (E′−E). In other words, the more internal stress is applied, the more deformation is caused to an actuator.

$$\begin{matrix}Formula 1 & \\ E = \frac{σ}{ɛ} & ( 1 ) \\ {E}^{′} = \frac{σ}{{ɛ}^{′}} & ( 2 ) \\ {ɛ}^{′} = \frac{E}{{E}^{′}} ɛ & ( 3 ) \\ ɛ - {ɛ}^{′} = σ \frac{{E}^{′} - E}{{EE}^{′}} & ( 4 )\end{matrix}$$

Thus, allowing a polymer film or fiber to be in a deformed state where an internal stress is generated by applying an external force, and causing absorption and desorption of molecules in the polymer film or fiber in the deformed state (the state of internal stress being generated) by an external stimulus, by which the elastic modulus of the polymer film or fiber changes, which enables unprecedentedly significant deformation to be caused.

As a deformed state in which an internal force is generated by applying an external force to a polymer film or fiber, at least one shape of an accordion shape, a leaf-spring shape, a wave shape and a zigzag shape is preferable. Specifically, it is preferable to bend a polymer film or fiber into a spring shape and to apply a voltage to the both ends as an external stimulus.

Regarding the absorption and desorption of molecules by an external stimulus, it is preferable for molecules to be water molecules in air for deforming a polymer film or fiber in the air.

The present invention is an actuator using a polymer film or fiber to be deformed by absorption and desorption of molecules by an external stimulus, which is activated by applying the external stimulus to the polymer film or fiber processed into a state where an internal force is generated.

It is preferable for the processed shape of a polymer film or fiber to be at least one of an accordion shape, a leaf-spring shape, a wave shape and a zigzag shape.

It is preferable for a voltage as the external stimulus to be applied to both ends of the polymer film or fiber being bent into an accordion shape or another above. By applying a voltage, vapor molecules are absorbed and desorbed from the surface of a polymer film or fiber bent into an accordion shape or another, which allows elastic modulus to be changed, and then a polymer actuator is significantly activated due to the relationship between the elastic modulus change and the internal force.

### Effects of the Invention

The present invention can provide a deformation method of a polymer film or fiber enabling deformation of 10 times or larger compared to the conventional deformation methods of a polypyrrole film or fiber by absorption and desorption of molecules by an external stimulus. This deformation method of a polymer film or fiber enables an actuator with unprecedentedly large displacement to be fabricated.

### BRIEF DESCRIPTION OF THE DRAWINGS

FIG. 1 shows the states of deformation in applying a DC voltage of 2 V to a spring-shaped actuator formed by folding a polypyrrole film in Example 1;

FIG. 2 shows the states in applying a DC voltage of 2 V to a polypyrrole film electropolymerized on a zigzag electrode in Comparative example;

FIG. 3 illustrates the change of electrically generated contractile stress in applying various strains to a polypyrrole film in Example 1;

FIG. 4 illustrates stress-strain curves of a polypyrrole film in applying various DC voltages in Example 1;

FIG. 5 is pattern diagrams illustrating the fabrication method and the voltage response of an accordion-shaped actuator using two polypyrrole films in Example 2;

FIG. 6 shows the states of deformation in applying a DC voltage of 2 V to an accordion-shaped actuator formed by folding two polypyrrole films;

FIG. 7 shows a cyclic voltage response characteristic of an accordion-shaped actuator formed by folding two polypyrrole films.

Hereinafter, the examples of the present invention will be described in detail, but the invention is not limited to them. A polymer film used in the following example was a polypyrrole film, which was produced by electropolymerization by dissolving 2.01 g of pyrrole and 5.43 g of tetraethylammonium tetrafluoroborate in 1% concentration of propylene carbonate to make 500 ml of solution, pouring the solution into an electropolymerization cell prepared using a platinum plate (length: 100 mm, width: 50 mm, thickness: 0.18 mm) for a positive electrode and an aluminum plate (length: 300 mm, width: 100 mm, thickness: 0.05 mm) for a negative electrode, and applying a constant current of 11 mA (current density 0.125 mA/cm²) from a potentiostat (HA-301, Hokuto Denko) for 12 hours. The temperature during the electropolymerization was −20 degree C. The obtained polypyrrole film was peeled from the platinum electrode and cleaned in propylene carbonate for approximately 5 minutes, and then dried in a vacuum.

### EXAMPLE 1

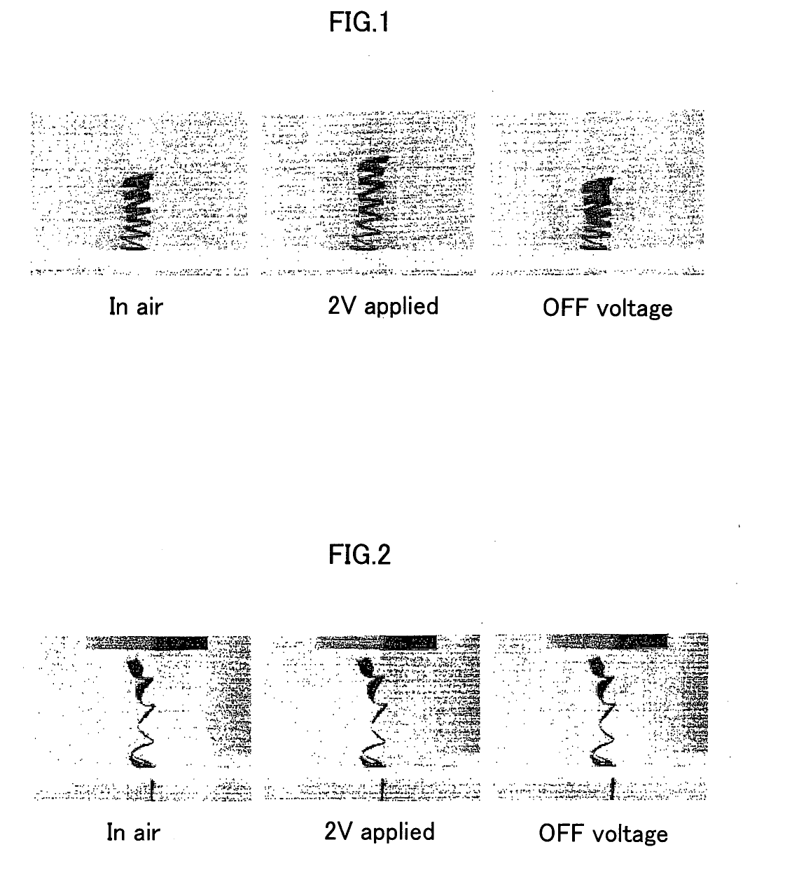

FIG. 1 shows the states of deformation in applying a DC voltage of 2 V to a spring-shaped actuator formed by folding a polypyrrole film into a zigzag pattern, which polypyrrole film has been produced by the method described above and cut to have a length of 36 mm, a width of 3 mm and a thickness of 20 μm.

In the present example, the polypyrrole film was folded 12 times into a zigzag pattern, to both ends of which a pair of copper wires having a diameter of 25 μm were fixed with silver paste, then a DC voltage of 2 V was applied from a potentiostat (HA-301, Hokuto Denko), and the images of the states of stretching and contraction at that time were captured with a video camera (DCR-PC300K, Sony).

A current of 38 mA flowed upon application of a voltage of 2 V, and the zigzag spring-shaped actuator was stretched by 22% in the longitudinal direction. In the air at the time, the bending angles of the bent parts increased to 25-35 degrees (the average was 31.1 degrees) upon the application of a voltage of 2 V compared to the bending angles of 19-31 degrees (the average was 25.1 degrees) before the application of a voltage, and it was found that the bending angles would increase approximately 24% upon application of a voltage. Also, the polypyrrole film was nearly restored to the original shape by stopping application of voltage.

The polypyrrole film contracted while absorbing and desorbing water molecules upon application of a voltage, and the contraction ratio was about 1-2%. The deformation ratio of the spring-shaped actuator (22%) is equivalent to more than 10 times compared to conventional techniques. This is considered because (1) the displacement of the spring-shaped actuator with bending of the polypyrrole film has been measured in the present example of the invention while the stretching/contraction of a polypyrrole film has been measured conventionally, and (2) as a result that the polypyrrole film has been folded repeatedly into a zigzag pattern, the units including the bent parts have been arranged in line, then the minor deformation with the change of bending angles upon application of a voltage has been accumulated one-dimensionally, in the result, which has enabled the significant stretch in one direction.

### COMPARATIVE EXAMPLE

By way of comparison with the zigzag-shaped polypyrrole film described above, a titanium board having a length of 100 mm, a width of 50 mm and a thickness of 50 μm was folded every 3 mm so as to have an angle of 50-60 degrees and used for an electrode, and then electropolymerization was performed under the same condition. The obtained polypyrrole film was cut to have a width of 3 mm after being cleaned and dried, by which a spring-shaped actuator being bent from the beginning was produced as shown in FIG. 2. A pair of copper wires having a diameter of 25 μm were fixed to both ends of the actuator with silver paste, then a DC voltage of 2 V was applied from a potentiostat (HA-301, Hokuto Denko), and the images of the states of stretching and contraction at that time were captured with a video camera (DCR-PC300K, Sony)

Although a current of 19 mA flowed upon application of a voltage of 2 V in air, the shape of the polypyrrole film hardly changed. Since the polypyrrole film was synthesized on the electrode folded into a zigzag pattern, the bent parts were not affected by deformation or strain such as elastic deformation, or external stress. Therefore, it was found generating internal stress (internal force) in a polypyrrole film in advance would be important so as to deform a spring-shaped actuator by applying a voltage. This is because the deformed volume (ε−ε′) is obtained by multiplying the internal stress (σ) by the difference of the elastic modulus (E′−E) as described above.

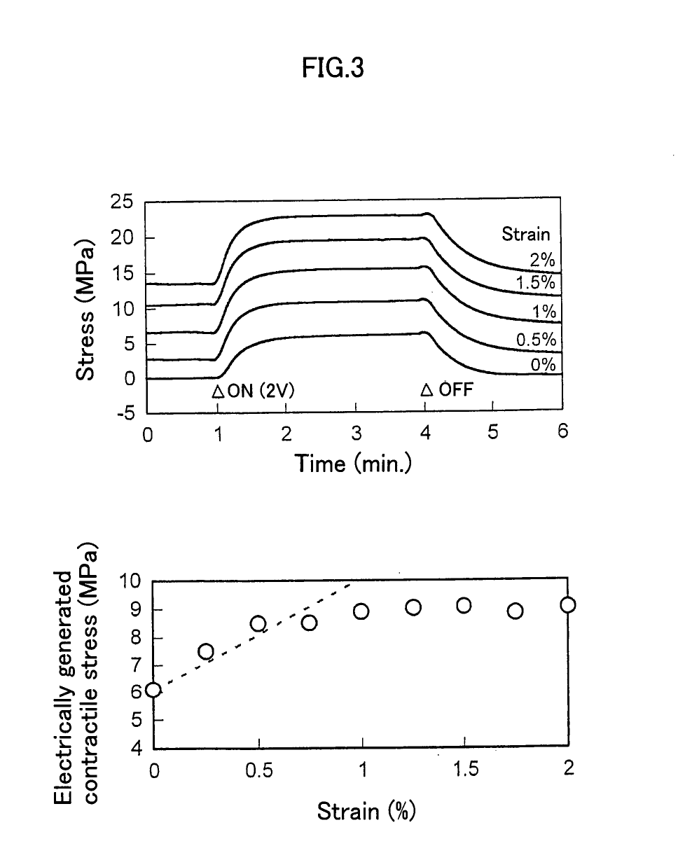

As a proof of the phenomenon above, the present inventor has found a phenomenon of change of contractile stress upon application of a voltage under tensile strain. FIG. 3 illustrates the change of contractile stress (hereinafter referred to as “electrically generated contractile stress”) in applying a voltage under the condition of applying various strains to a polypyrrole film. A polypyrrole film having a length of 35 mm, a width of 5 mm and a thickness of 30 μm was fixed to the chuck of a tension tester (Tensilon II, Orientech). A pair of copper wires were fixed to both ends of the polypyrrole film with silver paste, and then contractile stress was measured in applying a DC voltage using a potentiostat (HA-301, Hokuto Denko).The contractile stress of 6.1 MPa was generated by applying 2 V. The contractile stress was increased by stretching the polypyrrole film, and the greater contractile stress was generated by applying a voltage.

Interestingly, the electrically generated contractile stress when applying various strains to the polypyrrole film was increased to 9 MPa (1.5 times) by stretching the polypyrrole film by 1%. The current value, the surface temperature of the polypyrrole film measured by an infrared radiation thermometer (THI-500S, Tasco) and the relative humidity change around the surface of the polypyrrole film measured by a hygrometer (MC-P, Panametrics) were constant regardless of the applied strains, from which it has been considered that the increase of contractile stress is caused by the change of elastic modulus of a polypyrrole film.

A contractile stress generated by stretching a polypyrrole film is expressed as below in the case of not applying voltage (σ₀) and of applying voltage (σₑ), respectively:

σ₀=E₀ε, σₑ=Eₑ(ε+εₑ)/(1−εₑ)

The above-mentioned E₀ or Eₑ, respectively, is the elastic modulus of a polypyrrole film in the case of not applying voltage, and εₑ is the contraction ratio in the case of applying a voltage to a polypyrrole film without any tensile force. When εₑ<1, the electrically generated contractile stress (Δσₑ=σₑ−σ₀) is expressed in Δσₑ=Eₑεₑ+(Eₑ−E₀)ε, which shows that an electrically generated contractile stress is changed by a strain.

In other words, when the elastic modulus of a polypyrrole film is increased by applying a voltage (Eₑ>E₀), the electrically generated contractile stress is increased by applying a strain. On the other hand, when the elastic modulus is adversely decreased by applying a voltage (E_{e<E}₀), the electrically generated contractile stress is decreased.

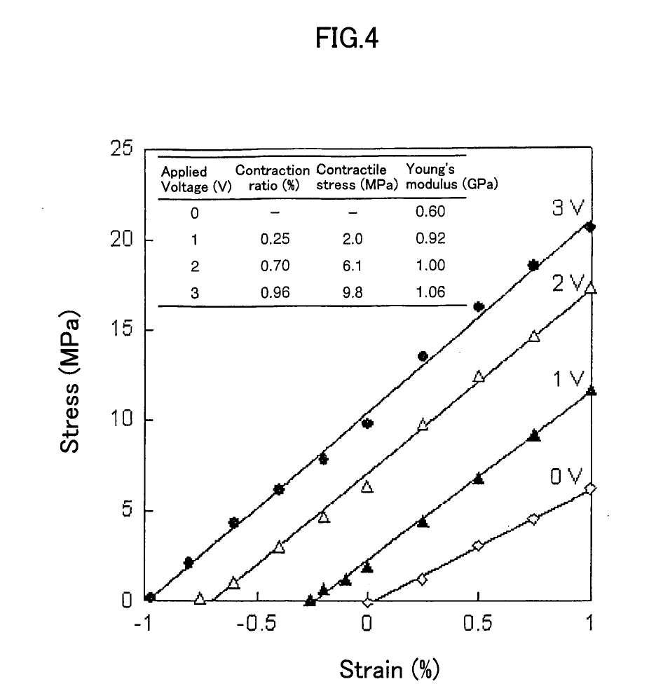

FIG. 4 illustrates the stress-strain characteristics of a polypyrrole film in applying various DC voltages. The polypyrrole film contracted with application of a voltage without any tensile force, and the contraction ratio increased with increasing applied voltage. Then, stretching the polypyrrole film gradually, the stress increased linearly. The longitudinal elastic modulus (Young's modulus) of the polypyrrole film calculated from the linear gradient of each line increased with increasing applied voltage, and increased approximately 60% with application of 2 V. This means that the polypyrrole film has been more difficult to deform due to electrical contraction.

The electrically generated contractile stress calculated using these numerical values is shown in a broken line in FIG. 3. Since the longitudinal elastic modulus of a polypyrrole film is increased by applying a voltage, the electrically generated contractile stress is increased with a strain. When the strain is 1% or less, the experimental values are closely matched to the calculated values, however, when the strain is more than 1%, the difference between them becomes larger. This has been considered because the plastic deformation of the polypyrrole film occurred, and actually, even though the strain was removed after stretching by 2%, the polypyrrole film was not fully restored to the original length. Therefore, it is considered that the increase of electrically generated contractile stress occurs only in the elastically deformable region of a polypyrrole film.

The deformation of the spring-shaped actuator shown in FIG. 1 can be described by the same mechanism as above. That is to say, the plastic deformation forming fold lines and the elastic modulus exhibiting spring characteristics are found in the bent parts of the spring-shaped actuator formed by folding a polypyrrole film.

Application of a voltage causes absorption and desorption of water molecules and contraction of a polypyrrole film, which leads to the increase of elastic modulus and allows the polypyrrole film to be more difficult to deform. Therefore, applying a force to reduce the elastic deformation (to reduce the strain) of the bent parts, that is, to restore the straight shape before folding allows the bent parts to be unfolded and the angles to be extended. It is considered that this allows the spring-shaped actuator to be stretched.

### EXAMPLE 2

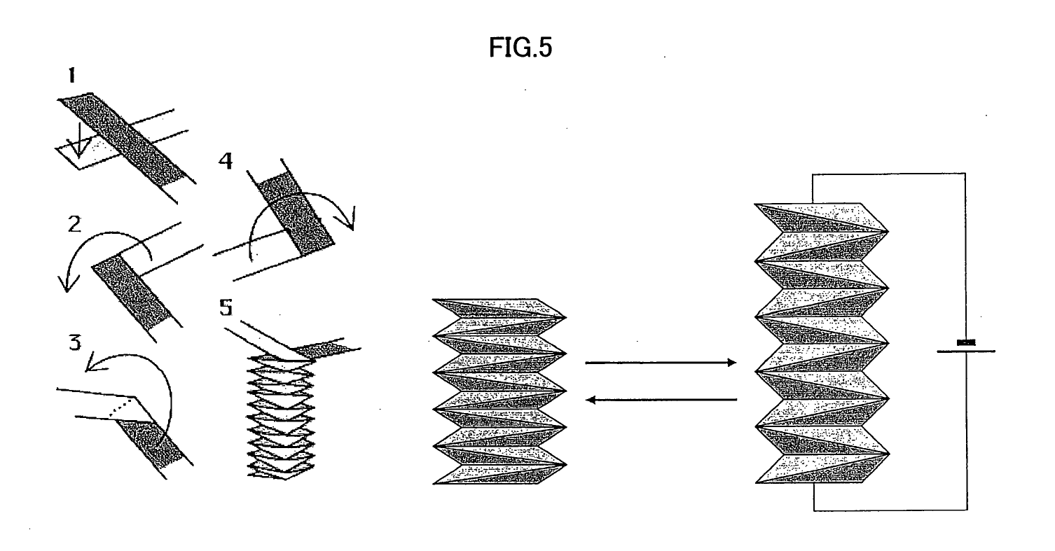

The spring-shaped actuator shown in FIG. 1 has high flexibility in the transverse direction and a problem to fall on its side during deformation. Then an accordion-shaped actuator was formed by alternately folding each of two polypyrrole films (length: 36 mm, width: 3 mm, thickness: 20 μm) as in FIG. 5.

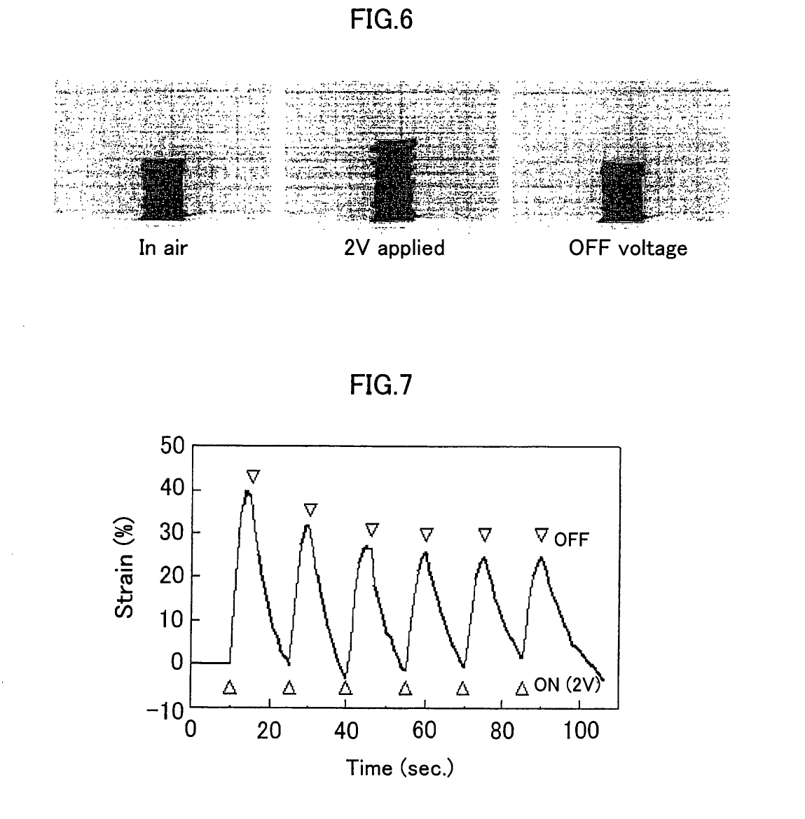

Despite using polypyrrole films of the same size (length: 36 mm, width: 3 mm, thickness: 20 μm) as that of FIG. 1, the first stretch of the accordion-shaped actuator (5 mm) using two polypyrrole films in FIG. 6 is approximately half the length of the spring-shaped actuator (9.5 mm) in FIG. 1. This is due to the limitation of flexible stretch of the accordion-shaped actuator using two polypyrrole films since it is formed by alternately folding each of two polypyrrole films.

As shown in FIG. 7, it has become clear that an actuator stretches reversibly upon application of a voltage of 2 V and that the stretch ratio reaches up to 40%. This is considered to be due to the increase of internal stress (effect of elastic deformation) since a polypyrrole film is folded into a more compact shape. The stretch of an actuator decreases through repeated application of voltages, and then it has been found that the stretch ratio becomes nearly constant (25%) with application of voltages three times or more.

### INDUSTRIAL APPLICABILITY

The present invention is applicable to electronic engineering devices such as a sensor using relationship between the absorption and desorption of molecules and the deformation of polymer films or fibers, or an artificial valve, a chemical valve and a switch to control the flow and direction of vapor, gas or liquid using the reversible deformation of polymer films or fibers.

Also, actuators and artificial muscle materials made to work directly using the deformation of polymer films or fibers are widely usable in industrial fields. Further, it is possible to obtain larger deformation and stress by arranging plane or three dimensional structures of polymer films or fibers folded two or three dimensionally in line and parallel.

1. A deformation method of a polymer film or fiber by absorption and desorption of molecules by an external stimulus, comprising: bringing the polymer film or fiber into a deformed state to have an internal force; and applying the external stimulus to the polymer film or fiber.

2. The deformation method of claim 1, wherein an elastic modulus of the polymer film or fiber in the deformed state is changed by absorption and desorption of the molecules by the external stimulus.

3. The deformation method of claim 1 or 2, wherein the polymer film or fiber in the deformed state is at least in one shape of an accordion shape, a leaf-spring shape, a wave shape and a zigzag shape.

4. The deformation method of claim 1, wherein the external stimulus is an electrical stimulus.

5. The deformation method of claim 1, wherein the molecules are water molecules in an air.

6. A polymer actuator using a polymer film or fiber to be deformed by absorption and desorption of molecules by an external stimulus, said polymer actuator being processed and formed so as to generate an internal force, and being activated after deformed by the external stimulus while the internal force is generated.

7. The polymer actuator of claim 6, wherein an elastic modulus of the polymer film or fiber is changed by absorption and desorption of the molecules by the external stimulus.

8. The polymer actuator of claim 6 or 7, wherein the polymer film or fiber is in a deformed state taking at least one of an accordion shape, a leaf-spring shape, a wave shape and a zigzag shape.

9. The polymer actuator of claim 6, wherein the external stimulus is an electrical stimulus.
